(19) United States
(12) Patent Application Publication
(10) Pub. No.: US 2015/0118145 A1
(43) Pub. Date: Apr. 30, 2015

(54) ULTRA-PURE HYDROGEN GENERATING METHOD AND DEVICE

(71) Applicant: Gennadiy Glazunov, Kharkov (UA)

(72) Inventor: Gennadiy Glazunov, Kharkov (UA)

(73) Assignee: AMAZONICA, CORP. DBA EURO AMERICAN HYDROGEN CORP, Las Vegas, NV (US)

(21) Appl. No.: 14/525,445

(22) Filed: Oct. 28, 2014

Related U.S. Application Data
(60) Provisional application No. 61/896,272, filed on Oct. 28, 2013.
(60) Provisional application No. 61/970,600, filed on Mar. 26, 2014.
(60) Provisional application No. 61/972,088, filed on Mar. 28, 2014.

(51) Int. Cl. C01B 3/00

(52) U.S. Cl. CPC C01B 3/0031
USPC 423/648.1; 422/211

(57) ABSTRACT

A device for generating ultra-pure hydrogen comprising a substantially cylindrical palladium tube having a first end and a second end, wherein the first end is hermetically sealed with a jointing technique; a collection end; a valve disposed within a hydrogen conductor having two ends, wherein the second end of the palladium tube is hermetically sealed to one end of the hydrogen conductor and the collecting end is connected to the other end of the hydrogen conductor; and a screen opposingly disposed from the flame source and about the substantially cylindrical diffusion-catalytic membrane, the central axis of the screen is disposed substantially parallelly with the central axis of the substantially cylindrical diffusion-catalytic membrane. In one embodiment, a fuel comprising gasoline and ethanol of a concentration ranging from about 2.5 to 10% by volume is provided.

### PRIORITY CLAIM AND RELATED APPLICATIONS

This non-provisional application claims the benefit of priority from provisional application U.S. Ser. No. 61/896,272 filed on Oct. 28, 2013, provisional application U.S. Ser. No. 61/970,600 filed on Mar. 26, 2014 and provisional application U.S. Ser. No. 61/972,088 filed on Mar. 28, 2014. Each of said applications is incorporated by reference in its entirety.

### BACKGROUND OF THE INVENTION

1. The Field of the Invention

This application relates generally to the chemical industry and hydrogen energetics, and more specifically, to an improved apparatus and method for generating ultra-pure gaseous hydrogen.

2. Background Art

There remain significant challenges in generating hydrogen with a purity of more than 99.99%. The use of ultra-pure hydrogen (purity of more than 99.999%) is of crucial importance for thermonuclear research using gas chromatographs and hydrogen analyzers, thermonuclear research laboratories, chemical and electronic industries, and the like. There are methods and devices to generate pure hydrogen operating on the basis of water or vapor electrolytic dissolution, such as those disclosed in Russian Federation Pat. No. 2142905 to Ermakov et al., 1999; U.S. Pat. No. 6,033,549 to Peinecke et al.; WO 2000000670 of Chambers; Self-Sufficient Solar-Hydrogen Plant by Timoshevskiy B. G., Tkach M. R., Shchyur D. V., Mukhachov A. P., Pishchuk V. K.; Book of abstracts of the 9th International Conference “Hydrogen Materials Science and Chemistry of Carbon Materials;” ICHMS′2005, Sevastopol, Ukraine, 2005, p. 584-585, etc. These devices are not economical due to their high energy consumption. The bond strengths between hydrogen and oxygen ions in the water molecule require energy input to break the bonds and release the free hydrogen. Additionally, systems are required to purify hydrogen and water vapor mixture produced via electrolysis.

One conventional method for manufacturing pure hydrogen employs costly photocells systems to generate electric power and devices for accumulating and purifying the produced hydrogen in hydride accumulators on the basis of intermetallides. Reference is made to Timoshevskiy B. G., Tkach M. R., Shchyur D. V., Mukhachov A. P., Pishchuk V. K. Self-Sufficient Solar-Hydrogen Plant; Book of abstracts of 9th International Conference “Hydrogen Materials Science and Chemistry of Carbon Materials;” ICHMS′2005. Sevastopol′, Ukraine, 2005, p. 584-585, for the use of photocells to produce hydrogen. Although these processes may not be economically unsound, they do not generate hydrogen with a purity of more than 99.99%.

Ultra-pure hydrogen can be generated by converting gaseous or liquid hydrocarbons (e.g., methane) followed by a filtering process via membrane technologies. Reference is made to Goltsov V. A. Hydrogen in Metals. In: Problems of Atomic Science and Technology. Series: Atomic and Hydrogen Energetics, Moscow: IAE, 1977, v. 1(2), p. 65-100 for a method to generate hydrogen using such a method. Since only hydrogen can pass through palladium (its alloys) and nickel membranes due to its extra high diffusivity in these metals, hydrogen is effectively filtered to ultra-pure standards.

Further, there exists a device for vapor catalytic conversion of methane. Using this device, hydrogen is extracted from the reaction zone through hydrogen-permeable membranes of Palladium-Ruthenium (Pd—Ru) alloy via a heating reaction with a helium heat-carrying medium as disclosed in Pozdeev V. V., Shangin B. V., Shopshin M. F. et al. Conversion Tube for Vapor Catalytic Conversion of Hydrocarbon Gases with Hydrogen Extraction from the Reaction Zone and with the Heating by Helium Heat-Carrying Medium. In: Problems of Atomic Science and Technology. Series: Nuclear Engineering and Technology, Moscow. IAE, 1989, v. 2, p. 66-68. In reaction volumes with gas-vapor mixture, there are palladium alloy capillaries wound on catalyst beds of reaction volume tubes. Capillaries and the catalysts are heated with high-temperature at a range of about 800-950° C. helium flow to about 530° C. Passing through the reaction volume tube, the gas-vapor mixture is heated and converted according to the reaction: CH₄+H₂O═CO+3H₂. The conversion gas transmits a portion of the hydrogen (due to the difference in partial pressures) beyond the reaction volume. This process and device is both energy-intensive (heating the membranes with the heat-carrying medium) and complex. Another drawback is the potential for carbon poisoning of the membrane surface (CO+H₂═H₂O+C) which will lead to instability and operational slowdown. Ultra-pure hydrogen is generated with combustion of hydrogen-containing inflammables near the surface of the diffusion-catalytic membrane to separate the volume of combustion from that of accumulation or consumption of pure hydrogen as disclosed in Glazunov G. P. (Hereinafter Glazunov) Method of Generating Ultra-pure Hydrogen. Ukrainian Pat. No. 86884. Bulletin No. 10, 2009. In that device, hydrogen is generated by hydrocarbon combustion (e.g., ethyl alcohol, gasoline, gas and the like) on the surface of the diffusion-catalytic membrane and its further diffusion through the membrane into the vacuum volume. The diffusion-catalytic membranes are manufactured as tubes hermetically attached to a hydrogen accumulator or collector at one end and hermetically brazed at the other. The device facilitates ultra-pure hydrogen generation by eliminating the need for additional purification upon hydrogen collection. Only hydrogen can pass through the diffusion-catalytic membrane, e.g., palladium and nickel membrane at about 700-800° C. temperature, separating other gases from the hydrogen. Several disadvantages are associated with Glazunov due to its poor reliability and maintainability. The process of hard brazing on the tube end plunged into the flame can cause Glazunov's collection devices to become depressurized in some operating modes, resulting in suspension of hydrogen production. It is very difficult to repair such a membrane consisting of several tubes, as their internal volumes must be isolated from their outer environment. Since the membrane material is not solid (i.e., the walls of the membrane are thin), there exists a possibility of destroying or damaging the membrane while assembling or repairing the device.

Thus, there is a need for a device and/or process for manufacturing ultra-pure hydrogen that is reliable, maintainable, economical to operate and whose productivity is high in light of conventional productivity.

### SUMMARY OF THE INVENTION

Disclosed herein is a device and a method for generating ultra-pure hydrogen using a flame source. In one embodiment, the device includes a substantially cylindrical diffusion-catalytic membrane connected to an output end, the substantially cylindrical diffusion-catalytic membrane having a first end 7, a second end 8, and a central axis. The first end 7 is hermetically sealed with a jointing technique. The device further includes at least one screen 16, 26 opposingly disposed from the flame source and about the substantially cylindrical diffusion-catalytic membrane. The central axis of the screen 16, 26 is disposed substantially parallelly with the central axis of the substantially cylindrical diffusion-catalytic membrane at a distance. The distance ranges from about 1 cm to about 2.5 cm.

In one embodiment, the screen is a semi-cylindrical screen. In another embodiment, the screen is a flat screen.

The output end includes a collection end 9 and a valve disposed within a hydrogen conductor 10 having two ends where the second end of the diffusion-catalytic membrane is hermetically sealed to a first end 11 of the hydrogen conductor and the collection end 9 is connected to a second end 12 of the hydrogen conductor.

In one embodiment, the diffusion-catalytic membrane is a palladium tube. In another embodiment, the diffusion-catalytic membrane is a palladium alloy tube.

In yet another embodiment, the diffusion-catalytic membrane is a nickel tube. In yet another embodiment, the diffusion-catalytic membrane is a nickel alloy tube.

In one embodiment, at least one screen is used in combination with the diffusion-catalytic membrane to further increase ultra-pure hydrogen productivity.

In another embodiment, one common screen is installed over a plurality of membrane tubes.

In yet another embodiment, the diffusion-catalytic membrane tube is a semi-toroid.

In yet another embodiment, the diffusion-catalytic membrane tube is a spiral.

In yet another embodiment, the diffusion-catalytic membrane tube is a helix coil.

In one embodiment, the collecting end is a collector 6. In another embodiment, the collecting end is a vacuum volume 4.

In one embodiment, the jointing technique is argon-arc welding.

In one embodiment, a container 34 is provided and the container 34 is disposed above a screen 16, 26 where a liquid disposed in the container 34 is configured to be heated using the waste heat generated by the same flame 14 configured to produce ultra-pure hydrogen in the device for generating ultra-pure hydrogen.

Accordingly, it is a primary object of the present invention to provide an ultra-pure hydrogen generating device that is reliable, maintainable, economical to operate and one which yields enhanced productivity over Applicant's ultra-pure hydrogen generating device using a substantially rectilinear diffusion-catalytic membrane without a screen.

Also disclosed is a method for generating ultra-pure hydrogen, the method comprising:
(a) providing a substantially cylindrical diffusion-catalytic membrane having a first end 7 and a second end 8, wherein the first end 7 is hermetically sealed with a jointing technique; a collection end 9; and a valve disposed within a hydrogen conductor 10 having two ends wherein the second end of the diffusion-catalytic membrane is hermetically sealed to a first end 11 of the hydrogen conductor and the collection end 9 is connected to a second end 12 of the hydrogen conductor.
(b) supplying a combustion of a fuel comprising gasoline and ethanol of a concentration, wherein said concentration is a percentage by volume of ethanol within a mixture of ethanol and gasoline; and
(c) heating said diffusion-catalytic membrane with said combustion to about 700-800° C.

In a preferred embodiment, the concentration ranges from about 2.5% to about 10%.

Accordingly, it is another object of the present invention to provide an ultra-pure hydrogen generating device that is capable of generating ultra-pure hydrogen at a productivity that is higher than that of an ultra-pure hydrogen generating device using only gasoline as its fuel and an ultra-pure hydrogen generating device that reduces environmental impact as compared to one where only gasoline is used as its fuel.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram depicting one embodiment of the present ultra-pure hydrogen generating device.

FIG. 2 is a diagram depicting another embodiment of the present ultra-pure hydrogen generating device.

FIG. 3 is a front orthogonal view of yet another embodiment of the present ultra-pure hydrogen generating device, depicting the use of a semi-cylindrical screen for increasing the productivity of hydrogen production.

FIG. 4 is a side orthogonal view of yet another embodiment of the present ultra-pure hydrogen generating device, depicting the use of a semi-cylindrical screen for increasing the productivity of hydrogen production.

FIG. 5 is a side orthogonal view of yet another embodiment of the present ultra-pure hydrogen generating device, depicting the use of a flat screen for increasing the productivity of hydrogen production.

FIG. 6 depicts specific hydrogen flow through diffusion-catalytic membrane or specific productivity with respect to the distance between the diffusion-catalytic membrane central axis and the screen.

FIG. 7 depicts specific hydrogen flow through diffusion-catalytic membrane or specific productivity with respect to temperature of the diffusion-catalytic membrane.

FIG. 8 depicts specific hydrogen flow through diffusion-catalytic membrane or specific productivity with or without the use of a screen, with respect to distance between the central axis of the diffusion-catalytic membrane and the edge of stove nozzle whose flame has been configured to immerse the diffusion-catalytic membrane with a flame.

FIG. 9 is a diagram depicting yet another embodiment of the present ultra-pure hydrogen generating device for hydrogen productivity measurements.

FIG. 10 is a diagram depicting specific hydrogen flow through diffusion-catalytic membrane (at about 700° C.) with respect to ethanol concentration in gasoline.

FIG. 11 is a plan view of an ultra-pure hydrogen generating device, depicting the use of a semi-toroidal shaped diffusion-catalytic membrane for increasing the productivity of hydrogen production.

FIG. 12 is a diagram depicting the productivity of variously shaped diffusion-catalytic membranes with respect to the distance between the membranes and their respective stove nozzles.

FIG. 13 is a diagram depicting the use of a screen in combination with the embodiment of FIG. 11.

FIG. 14 is a diagram depicting yet another embodiment of a diffusion-catalytic membrane suitable for ultra-pure hydrogen production.

FIG. 15 is a diagram depicting yet another embodiment of a diffusion-catalytic membrane suitable for ultra-pure hydrogen production.

FIG. 16 is a diagram depicting yet another embodiment of a diffusion-catalytic membrane suitable for ultra-pure hydrogen production.

FIG. 17 is a diagram depicting yet another embodiment of a diffusion-catalytic membrane suitable for ultra-pure hydrogen production.

### PARTS LIST

1—diffusion-catalytic membrane
2—the end of diffusion-catalytic membrane that is plunged into the influence of a hydrocarbon flame source
3—valve
4—vacuum volume
5—hydrocarbon flame source
6—collector
7—first end of diffusion-catalytic membrane
8—second end of diffusion-catalytic membrane
9—collection end of diffusion-catalytic membrane
10—hydrogen conductor
11—first end of hydrogen conductor
12—second end of hydrogen conductor
14—flame
16—semi-cylindrical screen
18—distance between edge of stove nozzle and central axis of diffusion-catalytic membrane
20—radius of diffusion-catalytic membrane
22—radius of semi-cylindrical screen
24—angle corresponding to sector of screen
26—flat screen
28—pump
30—vacuum-sensing device
32—mass-spectrometer
34—container for holding liquids, e.g., water
36—product flow
38—region under influence of hydrocarbon flame source
40—distance between screen and central axis of diffusion-catalytic membrane
42—inner radius
44—outer radius
46—cylindrical screen

### PARTICULAR ADVANTAGES OF THE INVENTION

The productivity of the present ultra-pure hydrogen generation device is higher compared to conventional ultra-pure hydrogen generation devices. The mechanism for increasing productivity of the present ultra-pure hydrogen is simple, inexpensive to construct, easy to install and serves a secondary purpose of physically protecting the diffusion-catalytic membrane from damage.

The disadvantages of conventional methods are related to their rather low productivity and the environmental problems in the case of gasoline combustion. The main objective of the invention is to improve the method and device to generate ultra-pure hydrogen by means of both enhancing its productivity and reducing environmental impact associated with ultra-pure hydrogen production. Although ultra-pure hydrogen generation methods have been disclosed, the present ultra-pure hydrogen generation method and device are capable of producing ultra-pure hydrogen at productivity previously unachievable. The diffusion-catalytic membrane is catalytically active to processes of thermal decomposition of the above-mentioned flammable materials and the diffusion-catalytic membrane separates the volume of flammable materials disposed on the outer environment of the membrane from the volume for pure hydrogen entry into the cavity of the membrane. Ultra-pure hydrogen is therefore generated from the flame of combustion of hydrogen-containing flammable materials, e.g., butane, ethanol, gasoline, etc.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

Disclosed herein is a device and a method with increased reliability and maintainability for generating and collecting ultra-pure hydrogen. As used in this specification, ultra-pure hydrogen means hydrogen gas with purity of at least about 99.999%. The present device includes diffusion-catalytic membranes that serve to separate a volume of hydrocarbon combustion from that of pure hydrogen accumulation or consumption. The membranes are manufactured as tubes that are hermetically sealed at one end and hermetically attached to the collector or the volume of pure hydrogen accumulation or consumption at the other.

Unlike prior devices, the end 2 of membrane tube 1 that is plunged into the flame of hydrocarbon combustion is hermetically welded. A valve 3 is provided in the hydrogen conductor connecting the membrane tube 1 to a collector 6, a vacuum volume 4, or a hydrogen consumption point.

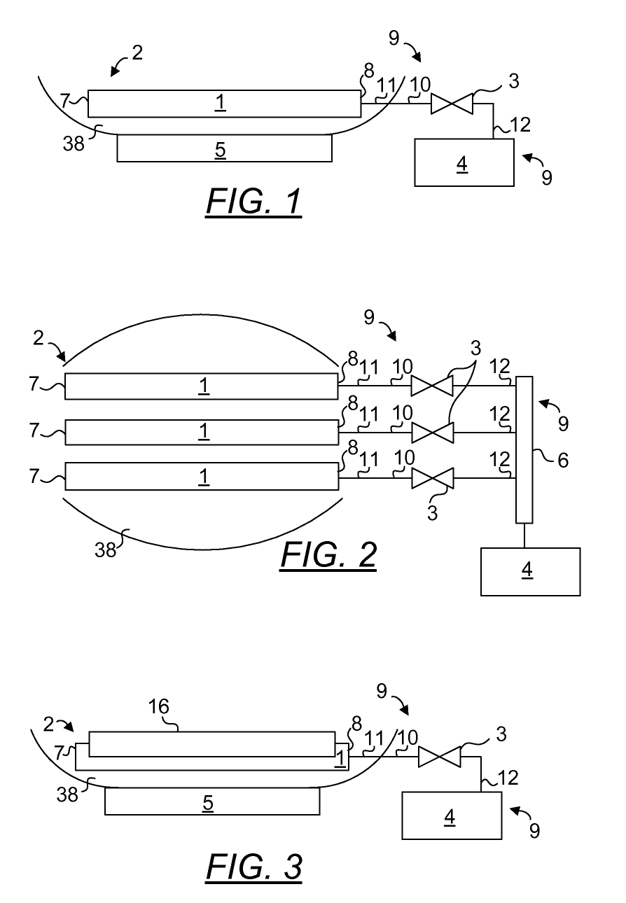

FIG. 1 is a diagram depicting one embodiment of the present ultra-pure hydrogen generating device. Only one diffusion-catalytic membrane 1 is shown. In one embodiment, the diffusion-catalytic membrane is a palladium tube or its alloys. In another embodiment, the diffusion-catalytic membrane is a nickel tube or its alloys. As used herein, the term “diffusion-catalytic membrane” may be used interchangeably with the term “palladium tube,” “nickel tube,” “membrane,” and “membrane tube.” In another embodiment, a diffusion-catalytic membrane is constructed from any metals or alloys catalytically active to processes of thermal decomposition of flammable hydrocarbon materials. In one embodiment, the membrane tube 1 is about 6 millimeters in diameter, about 0.25 millimeters in membrane wall thickness, and about 200 millimeters in length. The palladium tube 1 is connected to the vacuum volume 4 with a hydrogen conductor. The palladium tube 1 essentially isolates the atmosphere from the vacuum volume 4. A valve 3 is disposed within this hydrogen conductor to control the fluid flow through the hydrogen conductor and to measure the fluid flow rate through the hydrogen conductor to the vacuum volume 4. The palladium tube 1 is hermetically sealed at end 7 by argon-arc welding. Similarly, the opposing end of end 7, i.e., end 8 is also hermetically sealed to a hydrogen conductor by argon-arc welding.

FIG. 2 is a diagram depicting another embodiment of the present ultra-pure hydrogen generating device. In FIG. 2, three palladium tubes 1 are shown, each of which is connected via a hydrogen conductor to a collector 6. The collector 6 is in turn fluidly connected to a vacuum volume 4. Again, a valve 3 is disposed within each hydrogen conductor.

The device operates in the following way. Each palladium tube 1 is placed within the influence of a hydrocarbon flame source 5. Examples of a hydrocarbon flame source 5 is a gasoline blow torch, stove, burner, etc. After igniting the gasoline blow torch 5, each palladium tube 1 is heated to about 500-800° C. (the temperature to which the palladium tube 1 is heated depends on the location of the palladium tube 1 within the influence 38 of the flame). When the temperature of the palladium tube 1 reaches about 700° C., a hydrogen flow of about 1.5 N·cm³/s (or 0.036 liter/hour or l/hour) passes from the flame to the vacuum volume 4. When the diffusion-catalytic membrane 2 is disposed at an average temperature of about 700° C., the measured pressure in the vacuum chamber 4 is about 0.15 Torr. Hydrogen flow (hereinafter Q) to the vacuum volume 4 becomes 1.3·(P−P₀)·S, where P₀ (expressed in Torr) is the initial pressure, P (expressed in Torr) is the measured final pressure and S (l/s) is the pumping speed. In the present system, S is about 5 l/s. Under such conditions, the Q that passes from the diffusion-catalytic membrane to the vacuum volume 4 is therefore about 1.3×0.15 (Torr)×5 (l/s) or about 1 Ncm³/s or about 3.6 l/h. Specific productivity q=Q/A (hereinafter q) or about 0.03 N·cm³/s·cm², where A is about 33 cm². When a screen 16, 26 is used, the temperature of the palladium tube 1 reaches about 700° C., a hydrogen flow of about 1.5 N·cm³/s (or 0.036 liter/hour or l/hour) passes from the flame to the vacuum volume 4. When the diffusion-catalytic membrane 2 is disposed at an average temperature of about 700° C., the measured pressure in the vacuum chamber 4 is about 0.46 Torr. The Q to vacuum volume 4 becomes 1.3·(P−P₀)·S, where P₀ (expressed in Torr) is the initial pressure, P (expressed in Torr) is the measured final pressure and S (l/s) is the pumping speed. In the present system, S is about 5 l/s. Under such conditions, the Q that passes from the diffusion-catalytic membrane to the vacuum volume 4 is therefore about 1.3×0.46 (Torr)×5 (l/s) or about 3 Ncm³/s or about 10 l/h. q=Q/A or about 0.091 N·cm³/s·cm², where A is the area of surface of the tube through which hydrogen flow occurs or about 33 cm². Therefore, with the use of a screen 16, 26, the productivity is about 3 times the productivity of the case without the use of a screen 16, 26.

As both ends of the palladium tube 1 are argon-arc welded, the palladium tube 1 is capable of being placed within the influence of the hydrocarbon flame source without becoming unsoldered and/or detached from the hydrogen conductor. As a valve 3 is disposed in the hydrogen conductor between each palladium tube 1 (hydrogen generating source) and a collector 6 (hydrogen collection facilitating device), a break down at a hydrogen generating source will not cause the device having more than one hydrogen generating source to shut down. The valve 3 connected to a broken down hydrogen generating source is closed to prevent intrusion of foreign gases through the broken down hydrogen generating source or release of hydrogen already received at the collector 6, thereby allowing continued operation of such device and increasing the reliability and maintainability of such device. The broken down hydrogen generating source can then be removed and repaired without affecting the operations from other hydrogen generating sources.

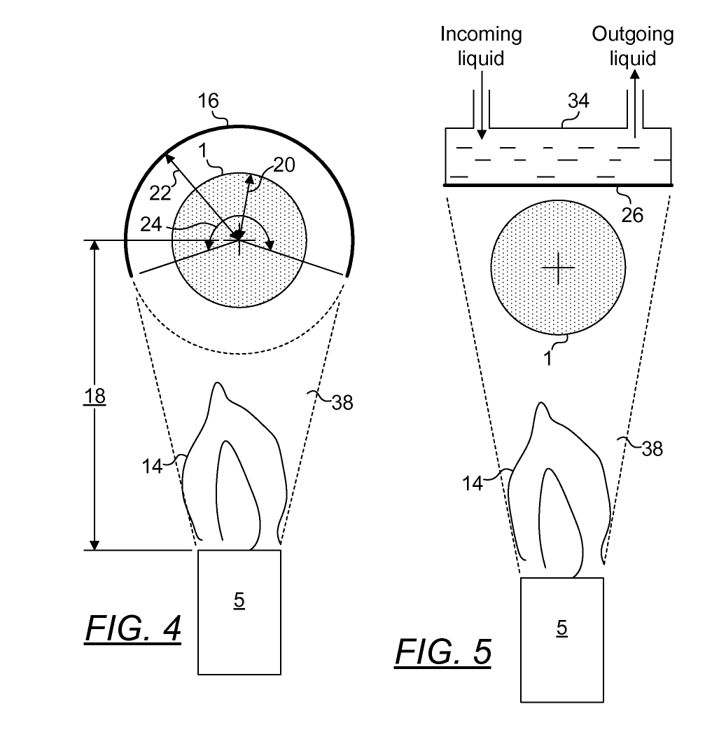

Two types of screen were investigated, i.e., a planar or flat screen measuring about 3 cm×20 cm and a semi-cylindrical screen (screen having semi-circular cross-sectional profile) with radius 22 of about 1.2 cm and length of about 20 cm. FIG. 3 is a front orthogonal view of yet another embodiment of the present ultra-pure hydrogen generating device, depicting the use of a semi-cylindrical screen 16 for increasing the productivity of hydrogen production. FIG. 4 is a side orthogonal view of yet another embodiment of the present ultra-pure hydrogen generating device, depicting the use of a semi-cylindrical screen 16 for increasing the productivity of hydrogen production. FIG. 5 is a side orthogonal view of yet another embodiment of the present ultra-pure hydrogen generating device, depicting the use of a flat screen 26 for increasing the productivity of hydrogen production. In this embodiment, it is further shown a mechanism for capturing waste heat generated by the flame 14. A container 34 is disposed above the screen 26 where a liquid disposed in the container 34 is configured to be heated by using the waste heat generated by the flame 14. In one embodiment, a flow is liquid is effected such that an incoming liquid is received and heated in the container 34 and the heated liquid is removed from the container 34 can be used for heating.

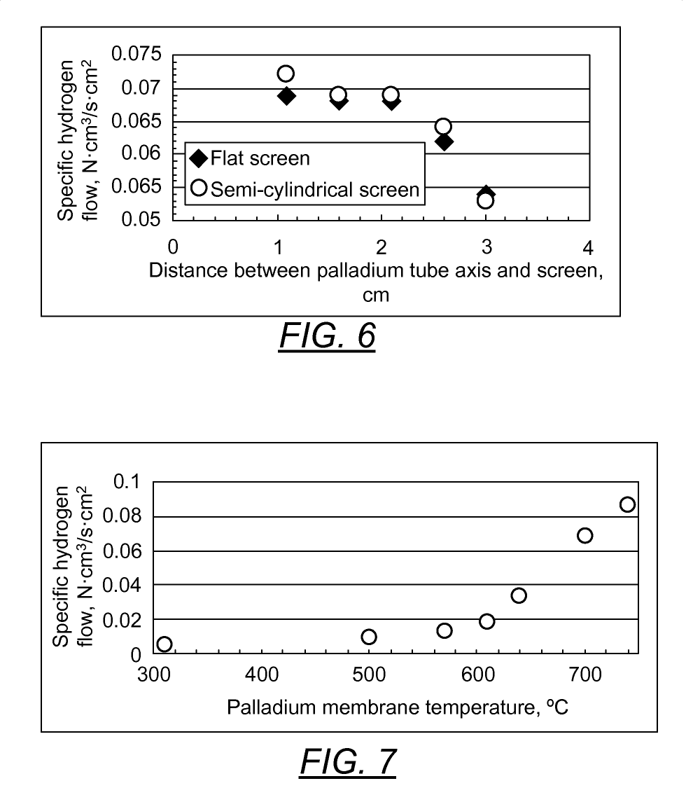

FIG. 6 depicts specific hydrogen flow through diffusion-catalytic membrane or specific productivity with respect to the distance between the palladium tube central axis and the screen. As shown in FIG. 6, the increase in productivity due to the use of any one of two types of screen is substantially the same. In a preferred embodiment, the distance 18 between the edge of stove 5 nozzle and the central axis of diffusion-catalytic membrane is from about 1 cm to about 2.5 cm. In one embodiment, the diameter of the palladium tube is about 6 mm. If the screen is made with a small width, e.g., significantly deviating for the width according to the relationships with other critical dimensions (e.g., those of the length of the screen, the diameter of the diffusion-catalytic membrane, etc.) of the diffusion-catalytic membrane and the screen as disclosed elsewhere herein, the effect of productivity increase of the use of the screen may be negligible. Flat screens of a width greater than about 3 cm were tested and yielded productivity results substantially similar to those of 3 cm wide screens. The Applicant discovered that the distance between the screen and the palladium tube is an important factor affecting hydrogen generation productivity. Preferable distances 18 range from about 1.1 to about 2.1 cm, with 1.1 cm being more preferable in obtaining maximum productivity. As an added benefit, a screen serves as a physical protector to the palladium tube. Between the two types of screen, the semi-cylindrical screen offers increased protection of the membrane from mechanical impacts as the semi-cylindrical screen covers a larger area. The precise radius of the screen is not critical. However the distance between a screen and a membrane shall be suitably large to avoid limiting flame flows to membrane surface especially to the top portion of the membrane surface in order to prevent screening of tube surface from the flame. In one embodiment, the screen radius measures about two tube diameters (or about 12 mm). If more than one tube is used, a larger flat screen is preferable as multiple tubes may be sufficiently encompassed by the larger flat screen. A screen of another shape and size may be used. The Applicant discovered however that a screen used for the purpose of increasing productivity of hydrogen production shall be disposed on one end of a diffusion-catalytic membrane and a flame source disposed on the opposite end of the diffusion-catalytic membrane, i.e., the diffusion-catalytic membrane is interposed between the flame source and screen. The screen shall also be disposed on the receiving end of the thermal effects of a flame source. In the present arrangement, a vertically disposed flame source-diffusion-catalytic membrane-screen combination is used. In another embodiment not shown, such arrangement may be disposed horizontally provided that the screen is disposed at the receiving end of the effects of the flame source. In yet another embodiment not shown, such arrangement may be disposed such that the screen and tube are disposed at a lower elevation than the flame source but a pressure differential is provided to cause the influence of the flame source to be felt at the tube. A screen reflects gaseous flows of the flame source that accumulates on the surface of the diffusion-catalytic membrane and stabilizes the temperature on the surface of the diffusion-catalytic membrane, thereby increasing the hydrogen productivity. It was also discovered that the thickness of the screen imparts insignificant influence in hydrogen productivity increase. In one embodiment, a stainless steel screen of about 0.3 to about 0.5 mm in thickness is sufficient to provide physical protection to the tube while increasing the productivity of hydrogen generation. Increasing the thickness of a screen does not significantly increase productivity of hydrogen production and physical protection of the tube but increases expenses associated with material costs. In one embodiment of a flat screen, the dimensions of the flat screen and its associated diffusion-catalytic membrane are related according to the following formula:

D·L=5·d·l,

where D (expressed in cm) is the width of a screen, L (expressed in cm) is the length of the screen, d (expressed in cm) is the diameter of the diffusion-catalytic membrane or twice the radius 20 of diffusion-catalytic membrane and “l” (expressed in cm) is the length of the diffusion-catalytic membrane. In the case of a semi-cylindrical screen, the radius (expressed in cm) of the screen is D/π, where D (expressed in cm) is the width of a flat screen before it is formed into the shape of a semi-cylindrical screen.

In one embodiment, in the case of multiple tubes, the dimensions of the flat screen and its associated diffusion-catalytic membrane are related according to the following formula:

D·L=(Dn+3)·l,

where Dn is diameter of the flame within which membrane tubes have been placed.

FIG. 6 depicts specific hydrogen flow through diffusion-catalytic membrane or specific productivity with respect to the distance between the palladium tube central axis and the screen. As shown in FIG. 6, specific productivity of the two types of screens, i.e., flat and semi-cylindrical are largely similar at distances 18 between about 1.1 to about 2.1 cm. As distance 18 increases, specific productivity drops. Therefore, there is an optimal distance 18 where hydrogen production at be maintained at high productivity. When compared to a case where a screen is not used, the present screen equipped diffusion-catalytic membrane shows productivity increases.

FIG. 7 depicts specific hydrogen flow or specific productivity through diffusion-catalytic membrane or specific productivity with respect to temperature of the palladium tube in the range of about 300-750° C. As shown in FIG. 7, the specific hydrogen flow is proportional of the palladium membrane temperature, i.e., as the temperature of the palladium membrane increases, the specific hydrogen flow also increases. In obtaining FIG. 7, the amount of hydrogen collected at vacuum volume 4 is plotted against the temperature of the tube. Although the screen temperature is directly measured, an estimate of the screen temperature can be inferred from the tube temperature, especially based on the temperature of the top portion of the tube (although a temperature offset is applied to the tube temperature as the tube is spaced a distance from the screen). For instance, when the temperature of the tube is about 700° C., the screen temperature is about 500° C. In another embodiment, the temperature of the screen may also be estimated based on the color it assumes when heated.

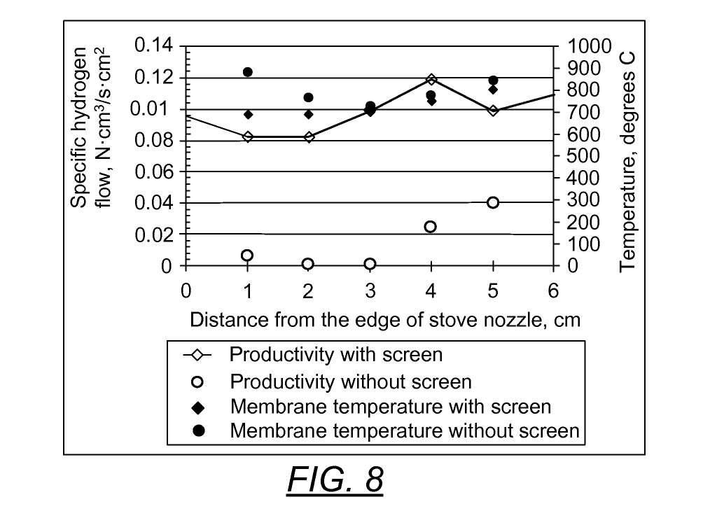

FIG. 8 depicts specific hydrogen flow through diffusion-catalytic membrane or specific productivity with or without the use of a screen, with respect to distance between the central axis of the diffusion-catalytic membrane and the edge of stove nozzle whose flame has been configured to immerse the diffusion-catalytic membrane. As shown in FIG. 8, the empty diamonds and circles represent specific productivity of hydrogen generation with and without the use of a screen, respectively. At 2 cm from the edge of stove, the productivity obtained with the use of a screen is about 0.083/0.0005 or 166 times the productivity without the use of a screen of 0.0005 N·cm³/s·cm². At 5 cm from the edge of stove, the productivity obtained with the use of a screen is about 0.1/0.04 or 2.5 times the productivity obtained without the use of a screen of 0.04 N·cm³/s·cm². It shall therefore be noted that the use of a screen increases the productivity of hydrogen production significantly.

In one embodiment of the present invention, a fuel mixture of ethanol and gasoline with ethanol concentration of from about 2.5% to 10% by volume is used as a hydrocarbon flame source instead of pure gasoline or pure ethanol. It is known that the combustion of ethanol does not increase atmospheric carbon dioxide levels. Therefore, when a mixture of gasoline and ethanol is used in the present combustion process, lower levels of atmospheric carbon dioxide can be expected compared to the use of a fuel of only gasoline. A mixture of from about 95% to about 15% by volume gasoline and from about 5% to about 85% vol. ethanol is widely used in internal-combustion engines in Europe, USA, Brazil, etc. However, it was not previously known the incorporation of ethanol in gasoline yields improvements in pure hydrogen production. According to experimental results disclosed elsewhere herein, the present use of ethanol/gasoline mixture provides not only reduced environmental impact, but also the enhancing productivity of hydrogen generation process by from about 25% to about 50%.

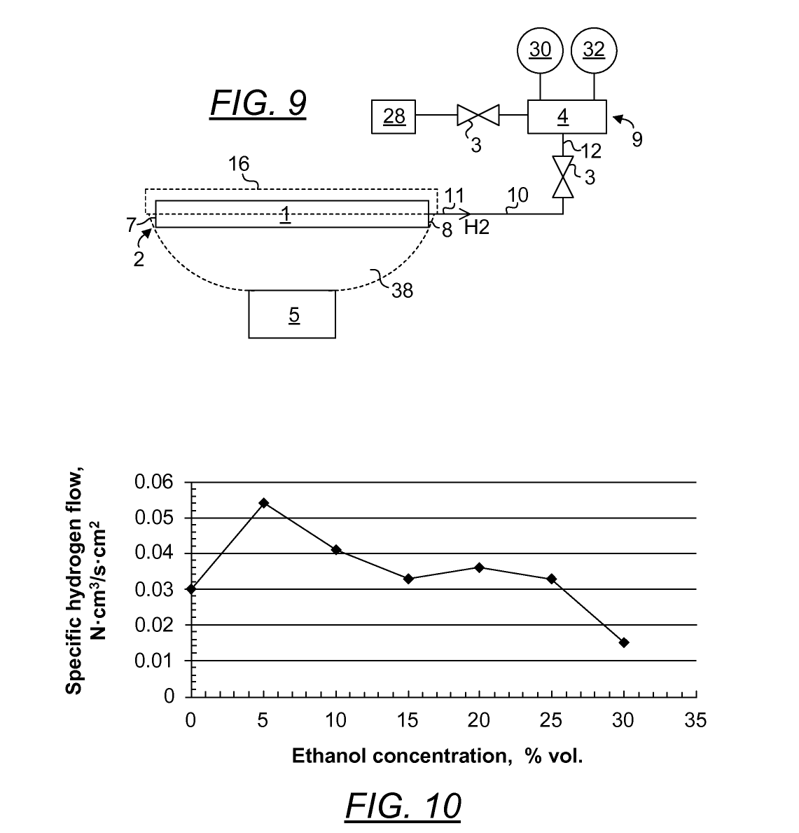

In one embodiment, ultra-pure hydrogen is collected without the use of a screen as shown in FIGS. 1 and 2. In another embodiment, ultra-pure hydrogen is collected with the use of a screen 16 as shown in FIG. 9. FIG. 9 is a diagram depicting another embodiment of the present ultra-pure hydrogen generating device for hydrogen productivity measurements. The device includes a diffusion-catalytic membrane, e.g., a palladium tube 1 with a diameter of about 6 mm, thickness of about 0.25 mm, and length of about 180 mm, where the tube is hermetically sealed by argon-arc welding at one end and attached to a valve 3 which in turn is connected to a vacuum volume 4 adapted to measure hydrogen flow at the other end. The diffusion-catalytic membrane is placed over the flame 14 of hydrocarbon combustion, e.g., a stove 5. In one example, ultra-pure hydrogen generation occurs in the following way. First, the internal volume of the diffusion-catalytic membrane 1, the vacuum chamber 4 and hydrogen conductors are pumped to a pressure of about 5×10⁻⁶ Torr. This pressure is measured by a vacuum-sensing device 30 and it is the initial pressure P₀. A mass spectrometer 32 is used to ensure that the substance collected is indeed ultra-pure hydrogen. Then the stove 5 is ignited and the palladium tube 1 is heated to from about 500 to about 800° C. (the temperature to which the palladium tube 1 is heated depends on the location of the palladium tube 1 within the influence of the flame or the flame intensity). In one embodiment, the temperature of the palladium tube 1 is controlled by a chromel-copel thermocouple. Hydrogen formed on the Palladium membrane surface facing the flame diffuses through the membrane and desorbs to the internal volume of the membrane. Hydrogen constitute the only gas that can pass through the diffusion-catalytic palladium membrane at from about 500 to about 800° C., which separates hydrogen from other gases. Thus, the generated hydrogen has a high purity, i.e., better than 99.999% by volume. As soon as hydrogen desorbs, the pressure P in the vacuum chamber 4 increases from the initial pressure of P₀. Then the high vacuum pumping is stopped and only 5 l/s forevacuum pumping using pump 28 is carried out. Measurements of hydrogen flow through diffusion-catalytic membrane which indicate ultra-pure hydrogen productivity are carried out with the method of constant pressure such as those disclosed in G. P. Glazunov, et al. Int. J. Hydrogen Energy. 1999. V. 24. P. 829-831. The term “productivity” as used herein is defined as the amount of hydrogen generated per unit time. Further, if the membrane surface area is taken into account, specific productivity can be calculated, i.e., the amount of hydrogen generated per unit of time per unit membrane surface area. As used herein, productivity units are expressed as normal cm³ of hydrogen per second (N·cm³/s) or liters of hydrogen per hour (l/hour). These units represent hydrogen flowrate or Q through the diffusion-catalytic membrane. The unit for specific hydrogen flow or q is therefore N·cm³/(s·cm²)=Q/A, where A is the membrane surface area. When the diffusion-catalytic membrane 2 is disposed an average of about 700° C., the measured pressure in the vacuum chamber 4 is about 0.15 Torr. The Q to vacuum chamber becomes 1.3·(P−P₀)·S, where P₀ (expressed in Torr) is the initial pressure, P (expressed in Torr) is the measured final pressure and S (l/s) is the pumping speed. In the present system, S is about 5 l/s. Under such conditions, the Q that passes from the diffusion-catalytic membrane to the vacuum volume 4 is therefore about 1.3×0.15 (Torr)×5 (l/s) or about 1 Ncm³/s or about 3.6 l/h. q=Q/A or about 0.03 N·cm³/s·cm², where A is about 33 cm².

Having described the conditions at which hydrogen is collected using the apparatus disclosed in FIG. 9, it is imperative to reveal the increase in hydrogen production when ethanol is added to a fuel of gasoline. Ethanol is added to gasoline in the following concentrations of about 5, 10, 15, 25 or 30% by volume. In these experiments, the average temperature of the diffusion-catalytic membrane 2 is held at about 700° C. Compared to the use of gasoline alone, the use of an ethanol mixture causes the measured pressure in the vacuum chamber 4 to be higher, indicating an increase in the specific hydrogen flow. FIG. 10 is a diagram depicting specific hydrogen flow through diffusion-catalytic membrane (at about 700° C.) with respect to ethanol concentration in gasoline. Each data point of FIG. 10 is the result of averaging three individual data points obtained in three separate experiments with an error of about 20%. Therefore, for the first specific productivity q value of 0.03 N·cm³/s·cm², the more precise expression may be written as 0.03 (+/−0.006) N·cm³/s·cm². In general, for an ethanol concentration of from about 2.5% to about 10% by volume, the specific productivity of hydrogen is enhanced by an average of from about 25% to about 50% compared to the case of pure gasoline combustion. Compared to the case without the use of ethanol at q=0.03 N·cm³/s·cm², the specific productivity is improved to about 0.04-0.054 N·cm³/s·cm². The Applicant discovered that further increase of ethanol concentration did not lead to hydrogen productivity enhancement and the regime of combustion becomes unstable. Thus, referring back to FIG. 10, the result of ethanol-gasoline mixture use is the enhancement of hydrogen productivity by from about 30% (i.e., a percentage point that is larger than the error of 20%) to (0.054-0.03) N·cm³/s·cm²/0.03 N·cm³/s·cm²=80%. In addition to productivity increase, environmental impact is reduced in case of using the combustion of the mixture of gasoline and ethanol instead of only gasoline. According to certain environmental impact studies, the use of fuel mixture with only about 5% ethanol decreases CO and CO₂ emission to environment by about 4-7%. It shall also be noted that, increasing the level of ethanol by 15 to 25% by volume only causes the minimal productivity increases. By increasing the ethanol concentration further beyond about 30%, the specific productivity drops below the level attained using only gasoline. Therefore, increasing the level of ethanol in a gasoline-ethanol mixture further not only fails to cause productivity increase but causes a decrease in productivity.

Similar productivity results are obtained using mixtures of gasoline and a gas (e.g., butane). Mixtures of gasoline and any one of the following hydrogen-containing spirits or gases may also increase the productivity of using pure gasoline. Example spirits include, but not limited to, methyl, propyl and butyl. Example gases include, but not limited to, methane, propane and ethylene.

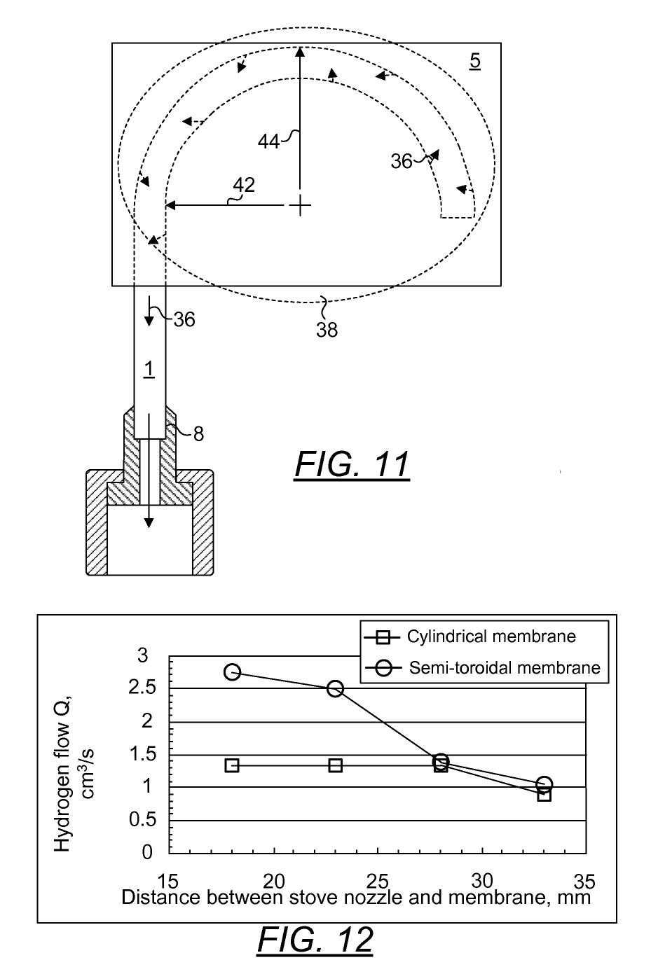

FIG. 11 is a plan view of an ultra-pure hydrogen generating device, depicting the use of a semi-toroidal shaped diffusion-catalytic membrane for increasing the productivity of hydrogen production. In this embodiment, the diffusion-catalytic membrane is formed in a semi-toroidal shape with the membrane having an inner radius 42 of about 3.5 cm and an outer radius 44 of about 4.1 cm. Compared to a straight cylindrical diffusion-catalytic membrane tube having similar dimensions including length, wall thickness and diameter (as shown in the configuration of FIG. 1), the semi-toroidal shaped membrane is found to yield a higher ultra-pure hydrogen productivity as shown in FIG. 12 when the distance 18 between the stove 5 nozzle and the membrane 1 is up to about 23 mm. FIG. 12 is a diagram depicting the productivity of variously shaped diffusion-catalytic membranes with respect to the distance between the membranes and their respective stove nozzles. It shall be noted that up to a distance 18 of about 23 mm, the hydrogen flow within the semi-toroidal membrane is about twice the magnitude of hydrogen flow of the cylindrical membrane shown in FIG. 1.

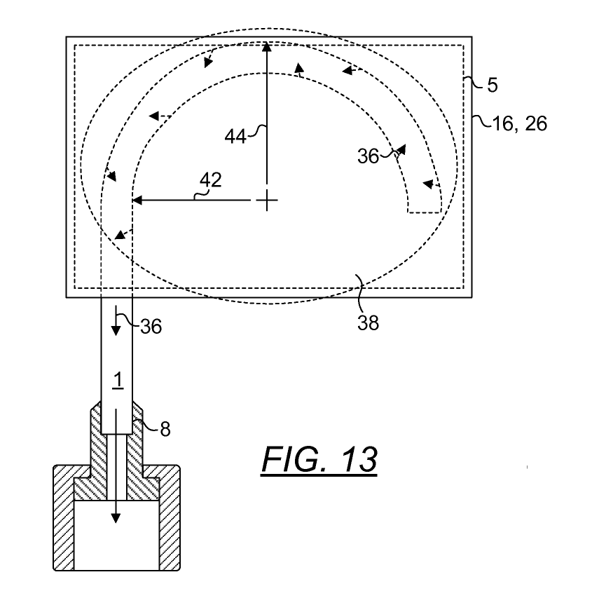

FIG. 13 is a plan view of an ultra-pure hydrogen generating device, depicting the use of a screen in combination with the embodiment of FIG. 11. It is possible to increase ultra-pure hydrogen further using a screen 16, 26 as shown.

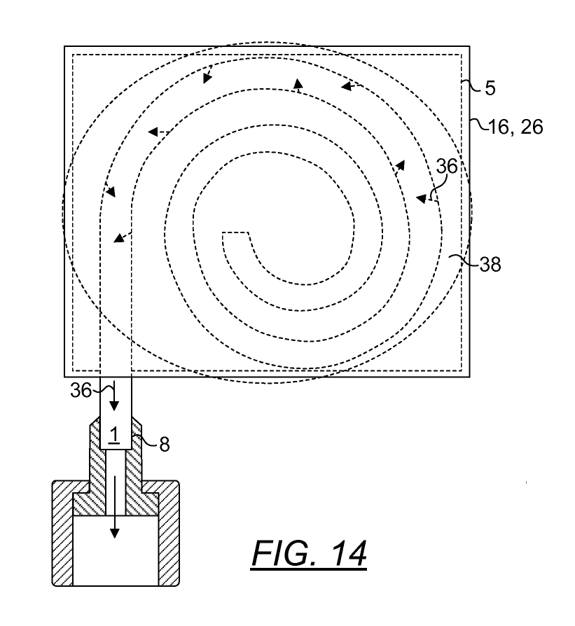

FIG. 14 is a diagram depicting yet another embodiment of a diffusion-catalytic membrane suitable for ultra-pure hydrogen production. The membrane 1 is essentially a spiral disposed in a plane. The configuration is also shown in combination with the use of a screen 16, 26. In one embodiment, the screen shown in FIGS. 11, 13 and 14 is a semi-cylindrical screen 16. In another embodiment, the screen shown in these figures is a flat screen 26.

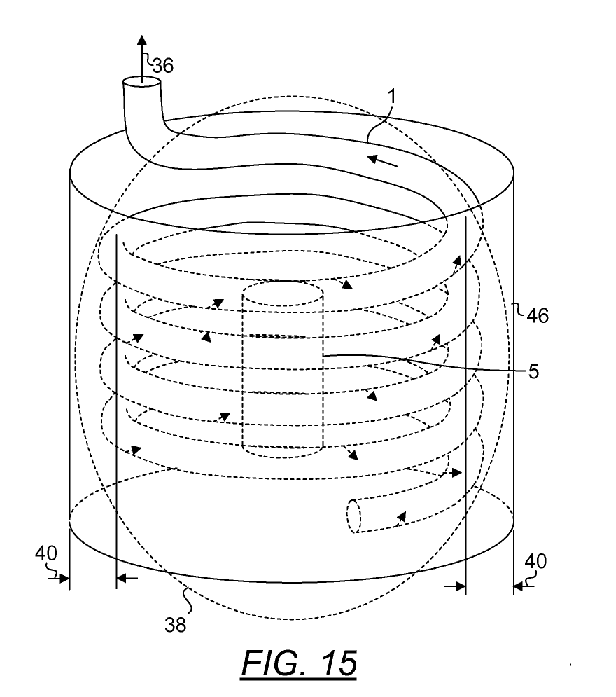

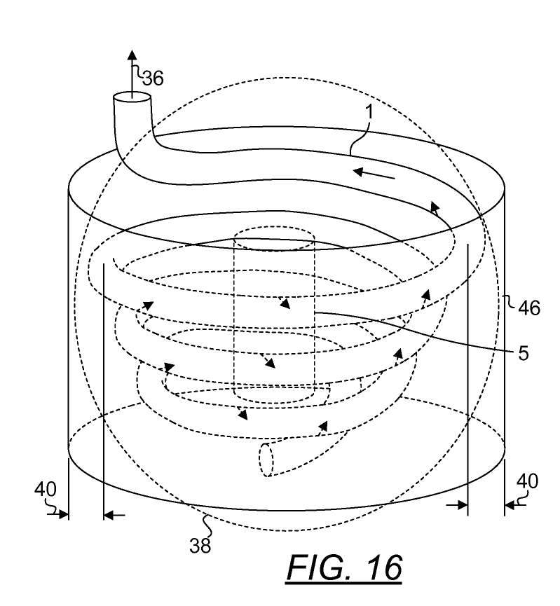

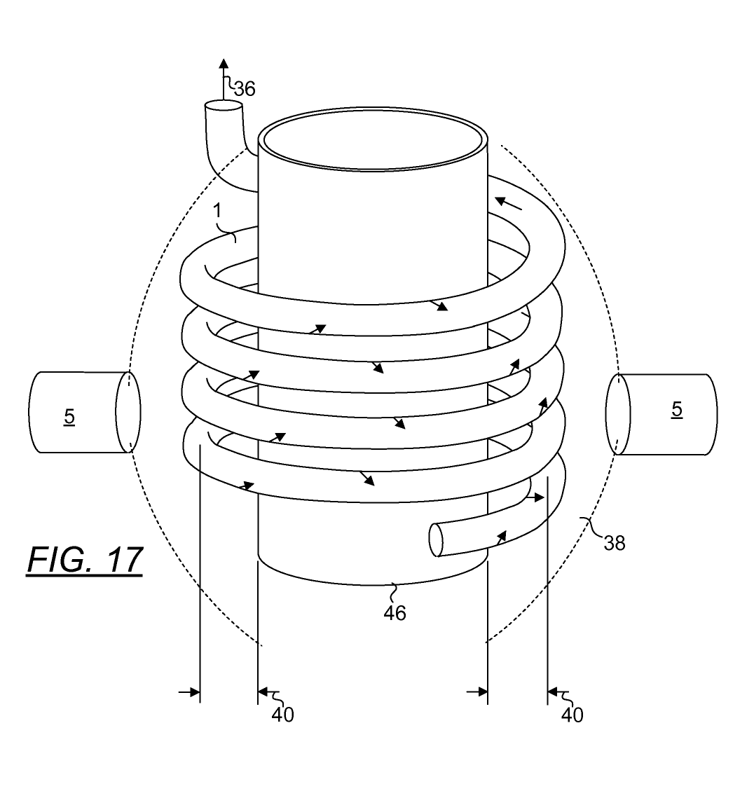

FIG. 15 is a diagram depicting yet another embodiment of a diffusion-catalytic membrane suitable for ultra-pure hydrogen production. In this embodiment, the membrane 1 is essentially a helix coil shaped diffusion-catalytic membrane. The flame source 5 is substantially centrally disposed within the lumen of the coil. Further shown is a screen 46 disposed around the coil at a distance 40 of from about 1 to about 2.5 cm. FIG. 16 is a diagram depicting yet another embodiment of a diffusion-catalytic membrane suitable for ultra-pure hydrogen production. This configuration is similar to the configuration of FIG. 15 except the coil is a spiral. FIG. 17 is a diagram depicting yet another embodiment of a diffusion-catalytic membrane suitable for ultra-pure hydrogen production. The membrane 1 of this embodiment is essentially a helix coil. However, a screen 46 that is essentially a cylinder is instead disposed substantially coaxially within the lumen of the coil. One or more flame sources 5 are provided on the outer periphery of the coil, effectively surrounding the coil such that suitable temperature of the coil can be established to cause hydrogen flow through the membrane. In one embodiment, the hydrocarbon flame source 5 of FIGS. 15 and 16 is delivered via a cylindrical burner arranged such that the flames from the burner roughly approximating the shape of the lumen within which the burner is disposed.

In shall be noted that in all instances where a screen is utilized to increase the productivity of ultra-pure hydrogen, the screen 16, 26, 46 is disposed at a location downstream of the influence of the combustion of a fuel where the diffusion-catalytic membrane is fully immersed in such influence.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A device for generating ultra-pure hydrogen using a flame source 5, said device comprising:
(a) a diffusion-catalytic membrane 1 connected to an output end, said diffusion-catalytic membrane 1 having a first end 7, a second end 8, and a central axis, wherein said first end 7 is hermetically sealed with a jointing technique; and
(b) a screen 16, 26 opposingly disposed from the flame source 5 and about said diffusion-catalytic membrane 1, wherein the central axis of said screen 16, 26 is disposed substantially parallelly with the central axis of said diffusion-catalytic membrane 1 at a distance 40.

2. The device of claim 1, wherein said jointing technique is argon-arc welding.

3. The device of claim 1, wherein said screen is a semi-cylindrical screen 16.

4. The device of claim 1, wherein said screen is a flat screen 26.

5. The device of claim 1, wherein the distance 40 ranges from about 1 cm to about 2.5 cm.

6. The device of claim 1, wherein said output end comprises:
(a) a collection end 9; and
(b) a valve 3 disposed within a hydrogen conductor 10 having two ends wherein said second end 8 of the diffusion-catalytic membrane 1 is hermetically sealed to a first end 11 of the hydrogen conductor 10 and the collection end 9 is connected to a second end 12 of the hydrogen conductor 10,
wherein said valve 3 is adapted to prevent intrusion of foreign gases in the device should said diffusion-catalytic membrane 1 becomes broken.

7. The device of claim 1, wherein said diffusion-catalytic membrane 1 is substantially cylindrical.

8. The device of claim 1, wherein said diffusion-catalytic membrane 1 is formed from a material selected from the group consisting of palladium and nickel.

9. A device for generating ultra-pure hydrogen using a flame source 5, said device comprising a non-rectilinear diffusion-catalytic membrane 1 connected to an output end, said diffusion-catalytic membrane having a first end 7, a second end 8, and a central axis, wherein said first end 7 is hermetically sealed with a jointing technique.

10. The device of claim 9, wherein said non-rectilinear diffusion-catalytic membrane 1 is a semi-toroid.

11. The device of claim 9, wherein said non-rectilinear diffusion-catalytic membrane 1 is a spiral.

12. The device of claim 9, wherein said non-rectilinear diffusion-catalytic membrane 1 is a helix coil.

13. The device of claim 10, further comprising a screen 16, 26 opposingly disposed from the flame source 5 and about said diffusion-catalytic membrane 1.

14. The device of claim 13, wherein said screen 16, 26 is constructed from a material selected from the group consisting of a semi-cylindrical screen 16 and a flat screen 26.

15. The device of claim 9, wherein said output end comprises:
(a) a collection end 9; and
(b) a valve 3 disposed within a hydrogen conductor 10 having two ends wherein said second end 8 of the diffusion-catalytic membrane 1 is hermetically sealed to a first end 11 of the hydrogen conductor 10 and the collection end 9 is connected to a second end 12 of the hydrogen conductor 10,
wherein said valve 3 is adapted to prevent intrusion of foreign gases in the device should said diffusion-catalytic membrane 1 becomes broken.

16. A method for generating ultra-pure hydrogen comprising:
(a) providing a diffusion-catalytic membrane 1 having a first end 7 and a second end 8, wherein said first end 7 is hermetically sealed with a jointing technique, a collection end 9, and a valve 3 disposed within a hydrogen conductor 10 having two ends wherein said second end 8 of the diffusion-catalytic membrane 1 is hermetically sealed to a first end 11 of said hydrogen conductor 10 and said collection end 9 is connected to a second end 12 of said hydrogen conductor 10;
(b) supplying a combustion of a fuel comprising gasoline and ethanol of a concentration, wherein said concentration is a percentage by volume of ethanol within a mixture of ethanol and gasoline; and
(c) heating said diffusion-catalytic membrane 1 with said combustion to about 700-800° C.

17. The method for generating ultra-pure hydrogen of claim 16, wherein said concentration ranges from about 2.5 to 10%.

18. The method for generating ultra-pure hydrogen of claim 16, wherein said concentration is about 5%.

19. The method for generating ultra-pure hydrogen of claim 16, further comprising disposing a screen 16, 26 at a location downstream of the influence of said combustion of said fuel.

20. The method for generating ultra-pure hydrogen of claim 16, wherein said screen 16, 26, 46 is a material selected from the group consisting of a semi-cylindrical screen 16, a flat screen 26 and a cylindrical screen 46.
